(19) United States
(12) Patent Application Publication
(10) Pub. No.: US 2020/0057515 A1
(43) Pub. Date: Feb. 20, 2020

(54) INCELL TOUCH DISPLAY PANEL AND DRIVING METHOD THEREOF

(71) Applicant: Wuhan China Star Optoelectronics Semiconductor Display Technology Co., Ltd., Wuhan (CN)

(72) Inventor: Jianhong LIN, Wuhan (CN)

(21) Appl. No.: 16/232,993

(22) Filed: Dec. 26, 2018

Related U.S. Application Data
(63) Continuation of application No. PCT/CN2018/104470, filed on Sep. 7, 2018.

(30) Foreign Application Priority Data
Aug. 17, 2018 (CN) 201810938267.3

(51) Int. Cl. G06F 3/044

(52) U.S. Cl. CPC G06F 3/044; G06F 2203/04103

(57) ABSTRACT

Provided are an incell touch display panel and a driving method thereof. The incell touch display panel includes: a driving circuit, a light emitting device, an integrated circuit and a plurality of cathodes; the driving circuit is connected to a signal input end of the light emitting device for driving the light emitting device to emit light; the cathode is connected to a signal output end of the light emitting device, and the cathode is configured to form a first capacitor with a sensed finger; the integrated circuit is connected to the cathode for receiving an electrical signal from the cathode, and for calculating a capacitance of the first capacitor, and determining a position of the first capacitor according to the capacitance of the first capacitor, or connecting the cathode to a common ground voltage signal. A thickness of a touch display panel can be reduced.

### CROSS-REFERENCE TO RELATED APPLICATION

This application is a continuing application of PCT Patent Application No. PCT/CN2018/104470 entitled “Incell touch display panel and driving method thereof”, filed on Sep. 7, 2018, which claims priority to Chinese Patent Application No. 201810938267.3, filed on Aug. 17, 2018, both of which are hereby incorporated in its entireties by reference.

### FIELD OF THE INVENTION

The present invention relates to a display technology field, and more particularly to an incell touch display panel and a driving method thereof.

### BACKGROUND OF THE INVENTION

OLED (Organic Light-Emitting Diode) displays possesses advantages of wide color gamut, high contrast, energy saving and foldability, so they are highly competitive in the new era of displays. AMOLED (Active-matrix organic light emitting diode) display technology is one of the key development directions of flexible display. The basic driving circuit of the AMOLED display can be 3T1C, as shown in FIG. 1, which includes a switching thin film transistor T1, a driving thin film transistor T2, an enabling thin film transistor T3 and a storage capacitor Cst. The driving current of the OLED is controlled by the driving thin film transistor T2, and the switching thin film transistor T1 determines that the data signal enters the gate of the driving thin film transistor T2 to control the current of the driving thin film transistor T2, and the enable thin film transistor T3 controls whether the current corresponding to the power supply voltage signal VDD flows through the OLED, and determines whether the OLED emits light. In practical applications, the mobile phone display screens are all equipped with touch functions. At present, most of the OLED displays on the market utilize external touch screens. In addition to the increase in thickness, new materials need to be developed in the bending demand, so there will be a relatively higher threshold for the production of the OLED display.

### SUMMARY OF THE INVENTION

To solve the above technical problem, the present invention provides an incell touch display panel and a driving method thereof, which can reduce a thickness of a touch display panel without using an external touch screen, and the production threshold of the touch display panel can be lowered,

The present invention provides an incell touch display panel, comprising a driving circuit, a light emitting device, an integrated circuit and a plurality of cathodes;

wherein the driving circuit is connected to a signal input end of the light emitting device for driving the light emitting device to emit light;

the cathode is connected to a signal output end of the light emitting device, and the cathode is configured to form a first capacitor with a sensed finger;

the integrated circuit is connected to the cathode for receiving an electrical signal from the cathode, and for calculating a capacitance of the first capacitor, and determining a position of the first capacitor according to the capacitance of the first capacitor, or connecting the cathode to a common ground voltage signal.

Preferably, the integrated circuit comprises a first switching unit and an integrator;

a first end of the first switching unit is connected to the cathode, and a second end and a third end of the first switching unit are respectively connected to an input end of the integrator and the common ground voltage signal, and the first switching unit is configured to connect the cathode to the input end of the integrator or to connect the cathode to the common ground voltage signal;

the integrator is configured to acquire a capacitor voltage signal generated by the first capacitor, and to output the capacitor voltage signal.

Preferably, the integrated circuit further comprises a calculation and determination unit;

the calculation and determination unit is configured to receive the capacitor voltage signal from the integrator, and to determine the capacitance of the first capacitor and the position of the first capacitor.

Preferably, the integrator comprises an amplifier and a second capacitor;

two ends of the second capacitor are respectively connected to a first input end and an output end of the amplifier;

the first input end of the amplifier is also connected to the second end of the first switching unit, and a second input end of the amplifier is connected to a reference voltage signal,

Preferably, a number of the first switching unit and a number of the integrator are multiple, and the cathode and the first switching unit are connected in one-to-one correspondence, and the first switching unit and the integrator are connected in one-to-one correspondence.

Preferably, the driving circuit comprises a first thin film transistor, a second thin film transistor, a second switching unit and a third capacitor;

a drain and a gate of the first thin film transistor are respectively connected to a data signal and a switching signal, and a source of the first thin film transistor is connected to a gate of the second thin film transistor;

a drain of the second thin film transistor is connected to a power supply voltage signal, and a source of the second thin film transistor is connected to the light emitting device through the second switching unit; the second switching unit is configured to control connection or disconnection between the second thin film transistor and the light emitting device;

two ends of the third capacitor are respectively connected to the gate and the drain of the second thin film transistor.

Preferably, the driving circuit is fixed on a flexible circuit board.

The present invention further provides an incell touch display panel, comprising a driving circuit, a light emitting device, an integrated circuit and a plurality of cathodes;

wherein the driving circuit is connected to a signal input end of the light emitting device for driving the light emitting device to emit light; and the driving circuit is fixed on a flexible circuit board;

the cathode is connected to a signal output end of the light emitting device, and the cathode is configured to form a first capacitor with a sensed finger;

the integrated circuit is connected to the cathode for receiving an electrical signal from the cathode, and for calculating a capacitance of the first capacitor, and determining a position of the first capacitor according to the capacitance of the first capacitor, or connecting the cathode to a common ground voltage signal;

wherein the integrated circuit comprises a first switching unit and an integrator;

a first end of the first switching unit is connected to the cathode, and a second end and a third end of the first switching unit are respectively connected to an input end of the integrator and the common ground voltage signal, and the first switching unit is configured to connect the cathode to the input end of the integrator or to connect the cathode to the common ground voltage signal;

the integrator is configured to acquire a capacitor voltage signal generated by the first capacitor, and to output the capacitor voltage signal.

Preferably, the integrated circuit further comprises a calculation and determination unit;

the calculation and determination unit is configured to receive the capacitor voltage signal from the integrator, and to determine the capacitance of the first capacitor and the position of the first capacitor.

Preferably, the integrator comprises an amplifier and a second capacitor;

two ends of the second capacitor are respectively connected to a first input end and an output end of the amplifier;

the first input end of the amplifier is also connected to the second end of the first switching unit, and a second input end of the amplifier is connected to a reference voltage signal.

Preferably, a number of the first switching unit and a number of the integrator are multiple, and the cathode and the first switching unit are connected in one-to-one correspondence, and the first switching unit and the integrator are connected in one-to-one correspondence.

Preferably, the driving circuit comprises a first thin film transistor, a second thin film transistor, a second switching unit and a third capacitor;

a drain and a gate of the first thin film transistor are respectively connected to a data signal and a switching signal, and a source of the first thin film transistor is connected to a gate of the second thin film transistor;

a drain of the second thin film transistor is connected to a power supply voltage signal, and a source of the second thin film transistor is connected to the light emitting device through the second switching unit; the second switching unit is configured to control connection or disconnection between the second thin film transistor and the light emitting device;

two ends of the third capacitor are respectively connected to the gate and the drain of the second thin film transistor.

The present invention provides a driving method of an incell touch display panel, applied in the incell touch display panel, comprising a driving circuit, a light emitting device, an integrated circuit and a plurality of cathodes;

wherein the driving circuit is connected to a signal input end of the light emitting device for driving the light emitting device to emit light;

the cathode is connected to a signal output end of the light emitting device, and the cathode is configured to form a first capacitor with a sensed finger;

the integrated circuit is connected to the cathode for receiving an electrical signal from the cathode, and for calculating a capacitance of the first capacitor, and determining a position of the first capacitor according to the capacitance of the first capacitor, or connecting the cathode to a common ground voltage signal.

wherein the driving method comprises steps of:

receiving electrical signals from the plurality of cathodes in sequence, and determining a capacitance of the first capacitor formed by the cathode and a finger according to the electrical signal, and determining a position of the first capacitor according to the capacitance of the first capacitor.

Preferably, the plurality of cathodes are arranged in an array, and the step of receiving the electrical signals from the plurality of cathodes in sequence comprises:

receiving the electrical signals from the plurality of cathodes row by row or column by column.

Preferably, as receiving the electrical signals from the plurality of cathodes in sequence, only electrical signals of a portion of cathodes in the plurality of cathodes are received each time, and the light emitting devices connected to the portion of the cathodes are disconnected from the corresponding driving circuit.

The embodiment of the present invention has benefits below: when a finger touches the corresponding cathode on the display panel, the first capacitor can be formed with the corresponding cathode. The integrated circuit can receive an electrical signal from the cathode, and calculate a capacitance of the first capacitor, and determine whether the first capacitor exists, i.e. can determine whether a finger touches on the cathode, and a position of the cathode touched by the finger can be determined by receiving the electrical signals of the plurality of cathodes in sequence. The integrated circuit can also connect the cathode to the common ground voltage signal to allow the light emitting device to emit light normally.

Therefore, the incell touch display panel provided by the present invention does not need an external touch screen, and does not increase the thickness of the touch display panel. When the touch display panel is bent, no new material is required, thus, lowering the production threshold of the touch display panel.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a driving circuit diagram of an Active Matrix Organic Light Emitting Diode (AMOLED) display provided by the present invention,

FIG. 2 is a connection diagram of a plurality of cathodes and an integrated circuit provided by the present invention.

FIG. 3 is a diagram of a driving circuit and an integrated circuit in an embodiment provided by the present invention.

FIG. 4 is a block diagram of an integrated circuit provided by the present invention.

FIG. 5 is a diagram of an integrated circuit provided by the present invention for collecting electrical signals from a cathode.

FIG. 6 is a first diagram of an integrated circuit provided by the present invention for connecting a cathode to a common ground voltage.

FIG. 7 is a second diagram of an integrated circuit provided by the present invention for connecting a cathode to a common ground voltage.

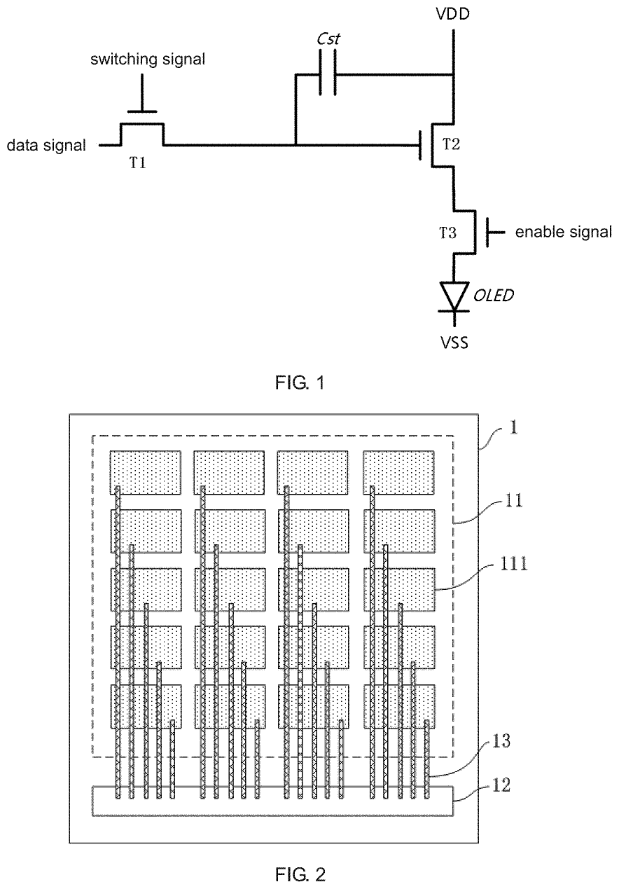

### DETAILED DESCRIPTION OF PREFERRED EMBODIMENTS

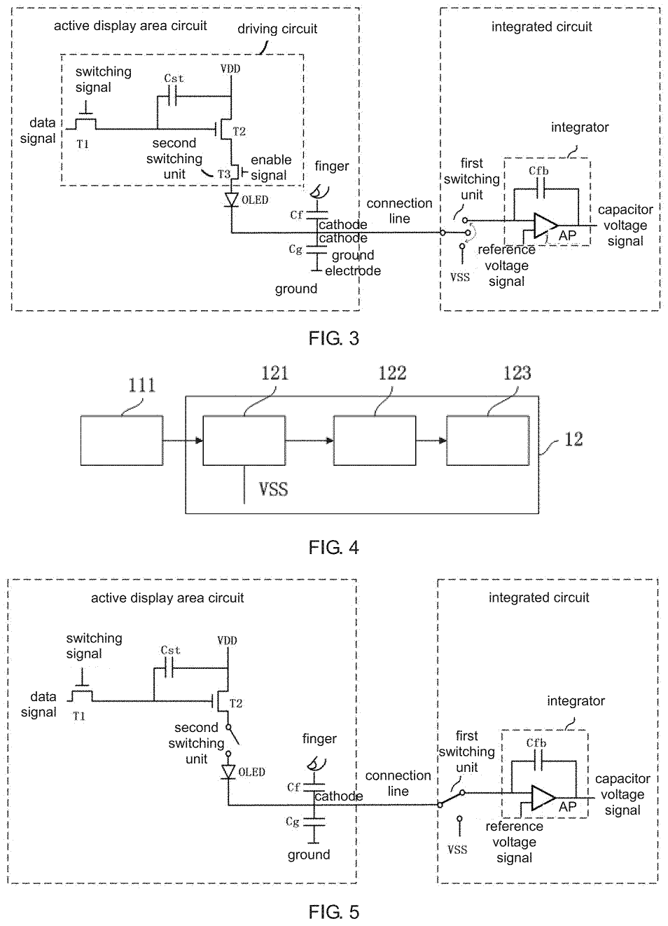

The present invention provides an incell touch display panel. As shown in FIG. 2, the incell touch display panel 1 includes an integrated circuit 12 and a plurality of cathodes 111, and further includes a driving circuit and light emitting device (Organic Light-Emitting Diode, OLED) shown in FIG. 3. Generally, the incell touch display panel 1 further includes a ground electrode.

The driving circuit is connected to a signal input end of the light emitting device (OLED) for driving the light emitting device (OLED) to emit light,

The cathode 111 is connected to a signal output end of the light emitting device (OLED), and the cathode 111 is configured to form a first capacitor Cf with a sensed finger. The cathode 111 also forms a fourth capacitance Cg with the ground electrode.

As shown in FIG. 3 and FIG. 4, the integrated circuit 12 is electrically connected to the cathode 111 through a connection line 13 for receiving electrical signals from the cathode 111 to calculate a capacitance of the first capacitor Cf, and to determine a position of the first capacitor Cf according to the capacitance of the first capacitor Cf, or connecting the cathode 111 to a common ground voltage signal VSS. All of the cathodes 111 are located in the active display area 11 of the incell touch display panel 1 and arranged in an array. The fourth capacitor Cg cannot be too large, otherwise the signal generated by the fourth capacitor Cg will affect the capacitance of the first capacitor Cf.

Furthermore, the integrated circuit 12 comprises a first switching unit 121 and an integrator 122.

A first end of the first switching unit 121 is connected to the cathode 111, and a second end and a third end of the first switching unit 121 are respectively connected to an input end of the integrator 122 and the common ground voltage signal VSS, and the first switching unit 121 is configured to connect the cathode 111 to the input end of the integrator 121 or to connect the cathode 111 to the common ground voltage signal VSS.

Here, the first switching unit 121 can be two switches, and each of the cathodes 11 can be connected to the integrator 122 and the common ground voltage signal VSS. When one of the switches is turned on, the other switch is turned off.

The integrator 122 is configured to acquire a capacitance voltage signal generated by the first capacitor Cf and output the capacitance voltage signal.

Furthermore, the integrated circuit 12 further comprises a calculation and determination unit 123. The calculation and determination unit 123 is configured to receive the capacitor voltage signal from the integrator 122, and to determine the capacitance of the first capacitor Cf and the position of the first capacitor Cf.

Furthermore, the integrator 122 comprises an amplifier and a second capacitor Cfb. Two ends of the second capacitor Cfb are respectively connected to a first input end and an output end of the amplifier. The first input end of the amplifier is also connected to the second end of the first switching unit 121, and a second input end of the amplifier is connected to a reference voltage signal. The second capacitor Cfb is configured to accumulate charges from the cathode 111 to form a voltage. The amplifier is used to compare a voltage across the second capacitor Cfb with the reference voltage signal to obtain a capacitor voltage signal and output the same.

Furthermore, a number of the first switching unit 121 and a number of the integrator 122 are multiple, and the cathode 111 and the first switching unit 121 are connected in one-to-one correspondence, and the first switching unit 121 and the integrator 122 are connected in one-to-one correspondence.

Furthermore, the driving circuit comprises a first thin film transistor T1, a second thin film transistor T2, a second switching unit and a third capacitor Cst. Here, the second switching unit may be a switch (such as a third thin film transistor T3 in FIG. 3). By inputting an enable signal to the switch, the switch is controlled to be connected or disconnected.

A drain and a gate of the first thin film transistor T1 are respectively connected to a data signal and a switching signal, and a source of the first thin film transistor T1 is connected to a gate of the second thin film transistor T2. The switching signal controls the first thin film transistor T1 to be turned on or off.

A drain of the second thin film transistor T2 is connected to a power supply voltage signal VDD, and a source of the second thin film transistor T2 is connected to the light emitting device OLED through the second switching unit; the second switching unit is configured to control connection or disconnection between the second thin film transistor T2 and the light emitting device OLED.

Two ends of the third capacitor Cst are respectively connected to the gate and the drain of the second thin film transistor T2.

Further, the driving circuit is fixed on a flexible circuit board.

The present invention further provides a driving method for the incell touch display panel 1, which is applied in the incell touch display panel 1 as aforementioned, and includes the following steps:

receiving electrical signals from the plurality of cathodes 111 in sequence, and determining a capacitance of the first capacitor Cf formed by the cathode 111 and a finger according to the electrical signal, and determining a position of the first capacitor Cf according to the capacitance of the first capacitor.

Furthermore, the plurality of cathodes 111 are arranged in an array, and the step of receiving the electrical signals from the plurality of cathodes 111 in sequence comprises:

receiving the electrical signals from the plurality of cathodes 111 row by row or column by column.

For instance, referring to FIG. 2, as receiving the electrical signals from the plurality of cathodes 111 in sequence, the first row of cathodes 111 in FIG. 2 may be first connected to the integrator 122 in the integrated circuit 12, while the cathodes 111 of the other rows are not connected to the corresponding integrators 122, and the integrator 122 corresponding to the first row of cathodes 111 can receive electrical signals from the first row of cathodes 111. Then, the second row of cathodes 111 is connected to the corresponding integrator 122, while the cathodes 111 of the other rows are not connected to the corresponding integrators 122 until the last row of cathodes 111 is connected to the corresponding integrator 122.

Similarly, when the electrical signals from the plurality of cathodes 111 are received column by column in sequence, the first column of cathodes 111 in FIG. 2 can be connected to the corresponding integrator 122, and the cathodes 111 of the other columns are not connected to the integrators 122. Then, the second column of cathodes 111 is connected to the corresponding integrator 122 until the last column of cathodes 111 is connected to the corresponding integrator 122.

Furthermore, as receiving the electrical signals from the plurality of cathodes 111 in sequence, only electrical signals of a portion of cathodes in the plurality of cathodes are received each time, and the light emitting devices OLED connected to the portion of the cathodes 111 are disconnected from the corresponding driving circuit.

For instance, as shown in FIG. 5, when the first switching unit 121 in the integrated circuit 12 establishes a connection between the cathode 111 and the integrator 122, the second switching unit of the driving circuit disconnects the driving circuit from the light emitting device LED.

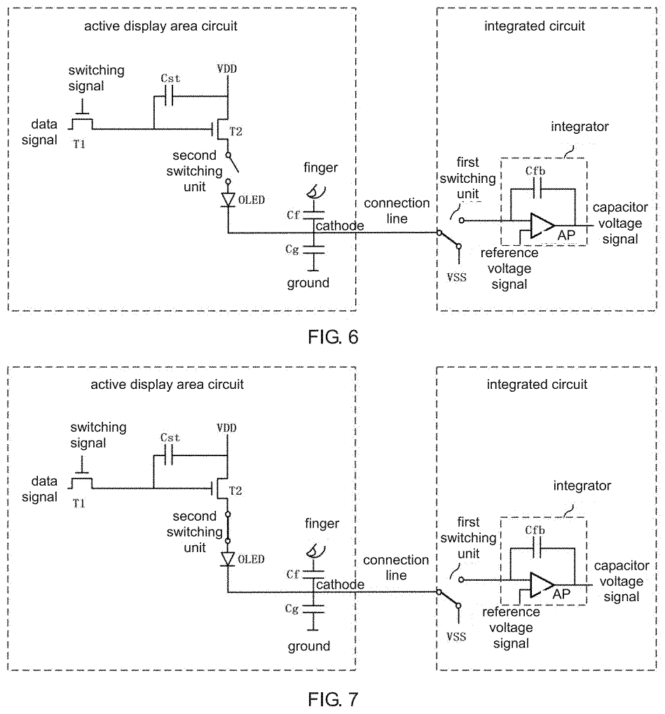

As shown in FIGS. 6 and 7, when the second switching unit in the integrated circuit 12 connects the cathode 111 to the common ground voltage signal VSS, the second switching unit can disconnect or establish a connection between the driving circuit and the light emitting device OLED.

The cathodes 111 in the incell touch display panel 1 of the present invention can be used both for an inductive mode and for a pixel mode. When the cathodes 111 are used for the inductive mode, the driving circuit is disconnected from the light emitting device OLED, and the light emitting device OLED connected to the cathode 111 does not emit light. Meanwhile, the cathode 111 is connected to the integrator 122 through the second switching unit, and the electrical signal from the cathode 111 is collected by the integrator 122. The capacitance of the first capacitance Cf formed by the cathode 111 and the finger is calculated according the electrical signal to determine whether the cathode 111 and the finger have formed the first capacitance Cf, so that it is possible to determine whether the position of the cathode 111 is touched by the finger. Furthermore, the plurality of cathodes 111 may be sequentially connected to the corresponding integrator 122, and the position of the cathode 111 touched by the finger may be determined by the capacitance voltage signal outputted by the integrator 122.

When the cathodes 111 are used for the pixel mode, the first switching unit 121 connects the cathode 111 to the common ground voltage signal VSS. When the driving circuit is connected to the light emitting device OLED, the light emitting device OLED can be driven to normally emit light.

Therefore, the incell touch display panel 1 provided by the present invention does not need an external touch screen, and does not increase the thickness of the touch display panel. When the touch display panel is bent, no new material is required, thus, lowering the production threshold of the touch display panel.

The above content with the specific preferred embodiments of the present invention is further made to the detailed description, the specific embodiments of the present invention should not be considered limited to these descriptions. Those of ordinary skill in the art for the present invention, without departing from the spirit of the present invention, can make various simple deduction or replacement, should be deemed to belong to the scope of the present invention.

What is claimed is:

1. An incell touch display panel, comprising a driving circuit, a light emitting device, an integrated circuit and a plurality of cathodes;
wherein the driving circuit is connected to a signal input end of the light emitting device for driving the light emitting device to emit light;
the cathode is connected to a signal output end of the light emitting device, and the cathode is configured to form a first capacitor with a sensed finger;
the integrated circuit is connected to the cathode for receiving an electrical signal from the cathode, and for calculating a capacitance of the first capacitor, and determining a position of the first capacitor according to the capacitance of the first capacitor, or connecting the cathode to a common ground voltage signal.

2. The incell touch display panel according to claim 1, wherein the integrated circuit comprises a first switching unit and an integrator;
a first end of the first switching unit is connected to the cathode, and a second end and a third end of the first switching unit are respectively connected to an input end of the integrator and the common ground voltage signal, and the first switching unit is configured to connect the cathode to the input end of the integrator or to connect the cathode to the common ground voltage signal;
the integrator is configured to acquire a capacitor voltage signal generated by the first capacitor, and to output the capacitor voltage signal.

3. The incell touch display panel according to claim 2, wherein the integrated circuit further comprises a calculation and determination unit;
the calculation and determination unit is configured to receive the capacitor voltage signal from the integrator, and to determine the capacitance of the first capacitor and the position of the first capacitor.

4. The incell touch display panel according to claim 2, wherein the integrator comprises an amplifier and a second capacitor;
two ends of the second capacitor are respectively connected to a first input end and an output end of the amplifier;
the first input end of the amplifier is also connected to the second end of the first switching unit, and a second input end of the amplifier is connected to a reference voltage signal.

5. The incell touch display panel according to claim 2, wherein a number of the first switching unit and a number of the integrator are multiple, and the cathode and the first switching unit are connected in one-to-one correspondence, and the first switching unit and the integrator are connected in one-to-one correspondence.

6. The incell touch display panel according to claim 1, wherein the driving circuit comprises a first thin film transistor, a second thin film transistor, a second switching unit and a third capacitor;
a drain and a gate of the first thin film transistor are respectively connected to a data signal and a switching signal, and a source of the first thin film transistor is connected to a gate of the second thin film transistor;
a drain of the second thin film transistor is connected to a power supply voltage signal, and a source of the second thin film transistor is connected to the light emitting device through the second switching unit; the second switching unit is configured to control connection or disconnection between the second thin film transistor and the light emitting device;
two ends of the third capacitor are respectively connected to the gate and the drain of the second thin film transistor.

7. The incell touch display panel according to claim 1, wherein the driving circuit is fixed on a flexible circuit board.

8. An incell touch display panel, comprising a driving circuit, a light emitting device, an integrated circuit and a plurality of cathodes:
wherein the driving circuit is connected to a signal input end of the light emitting device for driving the light emitting device to emit light; and the driving circuit is fixed on a flexible circuit board;
the cathode is connected to a signal output end of the light emitting device, and the cathode is configured to form a first capacitor with a sensed finger;
the integrated circuit is connected to the cathode for receiving an electrical signal from the cathode, and for calculating a capacitance of the first capacitor, and determining a position of the first capacitor according to the capacitance of the first capacitor, or connecting the cathode to a common ground voltage signal;
wherein the integrated circuit comprises a first switching unit and an integrator;
a first end of the first switching unit is connected to the cathode, and a second end and a third end of the first switching unit are respectively connected to an input end of the integrator and the common ground voltage signal, and the first switching unit is configured to connect the cathode to the input end of the integrator or to connect the cathode to the common ground voltage signal;
the integrator is configured to acquire a capacitor voltage signal generated by the first capacitor, and to output the capacitor voltage signal.

9. The incell touch display panel according to claim 8, wherein the integrated circuit further comprises a calculation and determination unit;
the calculation and determination unit is configured to receive the capacitor voltage signal from the integrator, and to determine the capacitance of the first capacitor and the position of the first capacitor.

10. The incell touch display panel according to claim 8, wherein the integrator comprises an amplifier and a second capacitor;
two ends of the second capacitor are respectively connected to a first input end and an output end of the amplifier;
the first input end of the amplifier is also connected to the second end of the first switching unit, and a second input end of the amplifier is connected to a reference voltage signal.

11. The incell touch display panel according to claim 8, wherein a number of the first switching unit and a number of the integrator are multiple, and the cathode and the first switching unit are connected in one-to-one correspondence, and the first switching unit and the integrator are connected in one-to-one correspondence,

12. The incell touch display panel according to claim 8, wherein the driving circuit comprises a first thin film transistor, a second thin film transistor, a second switching unit and a third capacitor;
a drain and a gate of the first thin film transistor are respectively connected to a data signal and a switching signal, and a source of the first thin film transistor is connected to a gate of the second thin film transistor;
a drain of the second thin film transistor is connected to a power supply voltage signal, and a source of the second thin film transistor is connected to the light emitting device through the second switching unit; the second switching unit is configured to control connection or disconnection between the second thin film transistor and the light emitting device;
two ends of the third capacitor are respectively connected to the gate and the drain of the second thin film transistor.

13. A driving method of an incell touch display panel, applied in the incell touch display panel, comprising a driving circuit, a light emitting device, an integrated circuit and a plurality of cathodes;
wherein the driving circuit is connected to a signal input end of the light emitting device for driving the light emitting device to emit light;
the cathode is connected to a signal output end of the light emitting device, and the cathode is configured to form a first capacitor with a sensed finger;
the integrated circuit is connected to the cathode for receiving an electrical signal from the cathode, and for calculating a capacitance of the first capacitor, and determining a position of the first capacitor according to the capacitance of the first capacitor, or connecting the cathode to a common ground voltage signal.
wherein the driving method comprises steps of:
receiving electrical signals from the plurality of cathodes in sequence, and determining a capacitance of the first capacitor formed by the cathode and a finger according to the electrical signal, and determining a position of the first capacitor according to the capacitance of the first capacitor.

14. The driving method of the incell touch display panel according to claim 13, wherein the plurality of cathodes are arranged in an array, and the step of receiving the electrical signals from the plurality of cathodes in sequence comprises:
receiving the electrical signals from the plurality of cathodes row by row or column by column.

15. The driving method of the incell touch display panel according to claim 13, wherein as receiving the electrical signals from the plurality of cathodes in sequence, only electrical signals of a portion of cathodes in the plurality of cathodes are received each time, and the light emitting devices connected to the portion of the cathodes are disconnected from the corresponding driving circuit.
